(19) United States
(12) Patent Application Publication
(10) Pub. No.: US 2014/0156399 A1
(43) Pub. Date: Jun. 5, 2014

(54) WHOLESALE FOOD MARKETING AND DISTRIBUTION PLATFORM

(71) Applicant: Meal Ticket, Boise, ID (US)

(72) Inventors: Wink Jones, Boise, ID (US); Brian Konrath, Boise, ID (US); Dan Henderson, Boise, ID (US); Colin McGrath, Boise, ID (US)

(73) Assignee: Meal Ticket, Boise, ID (US)

(21) Appl. No.: 14/095,342

(22) Filed: Dec. 3, 2013

Related U.S. Application Data
(60) Provisional application No. 61/732,785, filed on Dec. 3, 2012.
(60) Provisional application No. 61/781,657, filed on Mar. 14, 2013.

(51) Int. Cl. G06Q 30/02

(52) U.S. Cl. CPC G06Q 30/0255
USPC 705/14.53

(57) ABSTRACT

This disclosure describes systems, methods, and apparatus for facilitating sales, marketing, and order fulfillment between food industry manufacturers, distributors, and retailers. In particular, profiles of manufacturers, distributors, and retailers can be generated and these profiles can be analyzed to determine which retailers are ripe for promotional materials. Promotions can be created based on comparisons of manufacturer, distributor, and retailer profiles and the promotions can be transmitted via third-party servers. Retailers can then place orders via the third-party servers, and the third-party servers can then facilitate fulfillment of the orders with distributors.

### CLAIM OF PRIORITY UNDER 35 U.S.C. §119

The present Application for Patent claims priority to Provisional Application No. 61/732,785 entitled “WHOLESALE FOOD MARKETING AND DISTRIBUTION PLATFORM” filed Dec. 3, 2012, and Provisional Application No. 61/781,657 entitled “WHOLESALE FOOD MARKETING AND DISTRIBUTION PLATFORM” filed Mar. 14, 2013, both assigned to the assignee hereof and expressly incorporated by reference herein.

### FIELD OF THE DISCLOSURE

The present disclosure relates generally to sales and marketing platforms. In particular, but not by way of limitation, the present disclosure relates to systems, methods and apparatuses for creating and distributing promotional content in the wholesale food industry.

### BACKGROUND

Traditionally there is little transparency in the food industry supply chain (e.g., between manufacturers, distributors, and retailers). Distributor sales representatives market manufacturer products to retailers, but the effectiveness of sales is not shared with manufacturers for fear of affecting manufacturers' marketing and trade spend allocations or providing them an unfair market advantage. With little transparency in the supply chain, it is difficult for manufacturers to tailor promotions to the retailers who eventually purchase their products.

### SUMMARY OF THE DISCLOSURE

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

To overcome the lack of transparency between food industry manufacturers, distributors, and retailers, a third-party server system (e.g., MealTicket servers) takes manufacturer transaction data, retailer data (e.g., menu items and ingredient lists), and distributor data (that is provided to the third-party in exchange for compensation to the distributors), and generates promotions on behalf of manufacturers that retailers can use to make purchases that are then fulfilled by the distributors. In some embodiments, the distributors, for instance, through distributor sales representatives, can convey the promotions to the retailers.

Some aspects of the disclosure may be characterized as a non-transitory, tangible computer readable storage medium, encoded with processor readable instructions to perform a method for facilitating marketing and sales between food industry manufacturers, distributors, and retailers. The method can include parsing data collected regarding the food industry manufacturers, distributors, and retailers, including web crawling one or more websites to collect at least a portion of data on the food industry retailers. The method can further include populating profiles of the food industry retailers based on the parsing. The method can yet further include analyzing the food industry retailer profiles to select one or more food industry retailers for targeting of promotions for food products produced by one of the food industry manufacturers. The method can further include generating one or more promotions describing one or more food products produced by the one of the food industry manufacturers. The method can also include transmitting the one or more promotions to one of the food industry distributors for approval. The method can further include receiving approval of the one or more promotions from the one of the food industry distributors. Yet further, the method can include transmitting the one or more promotions to the one or more retailers selected for targeting of promotions. The method can additionally include receiving, in response to the transmitting, one or more food product orders from the one or more retailers selected for targeting of promotions. And yet further the method can include passing the food product orders to the one or more food industry distributors for fulfillment of the orders.

Other aspects of the disclosure may also be characterized as a non-transitory, tangible computer readable storage medium, encoded with processor readable instructions to perform a method for facilitating sales activities of a food industry distributor sales representative. The method can include parsing data collected regarding food industry manufacturers, distributors, and retailers. The method can also include populating profiles of the food industry retailers based on the parsing. The method can further include generating promotions and recommended products to be transmitted to the food industry distributor sales representative based on the profiles of the food industry retailers. The method can yet further include collecting location information from a mobile computing device of the food industry distributor sales representative. Yet further, the method can include comparing the location information to the profiles of the food industry retailers to predict what food industry retailer the mobile computing device is proximal to. The method can further include transmitting certain of the promotions and recommended products to the computing device, where the promotions and recommended products are predicted to be applicable to the food industry retailer that the mobile computing device is proximal to.

### BRIEF DESCRIPTION OF THE DRAWINGS

Various objects and advantages and a more complete understanding of the present invention are apparent and more readily appreciated by referring to the following detailed description and to the appended claims when taken in conjunction with the accompanying drawings:

FIG. 1 illustrates a system comprising a manufacturer, distributors, retailers, and one or more MealTicket servers;

FIG. 2 illustrates one embodiment of a method for selling food products;

FIG. 3 illustrates another embodiment of a method for selling food products;

FIG. 4 illustrates yet another embodiment of a method for selling food products;

FIG. 5 illustrates one embodiment of a user interface or web portal for managing marketing campaigns through the MealTicket servers;

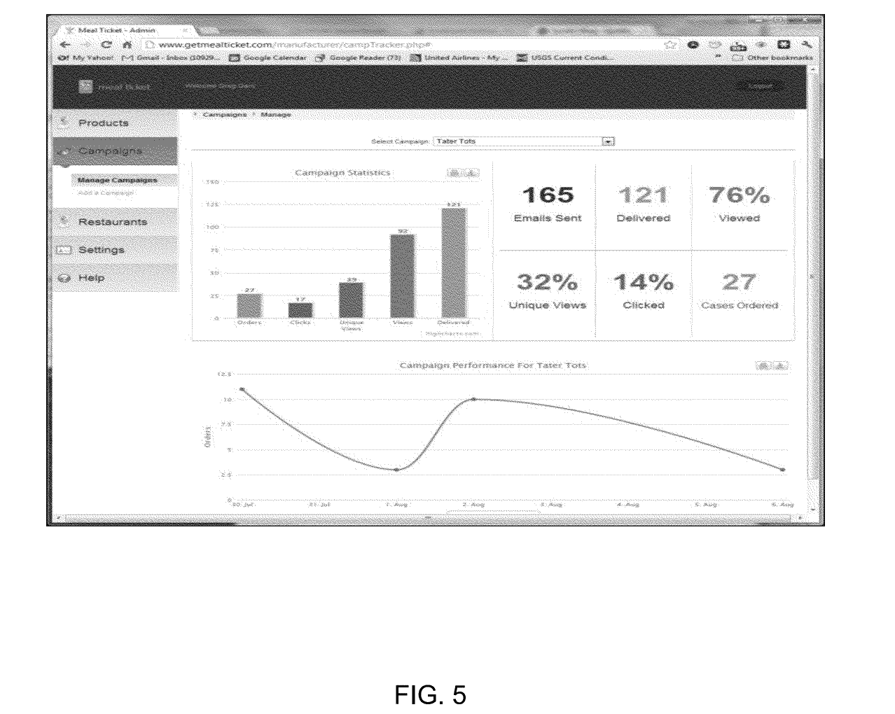

FIG. 6 illustrates a flow diagram of a method for facilitating marketing and sales between food industry manufacturers, distributors, and retailers;

FIG. 7 illustrates an embodiment of a user interface displaying a manufacturer promotion;

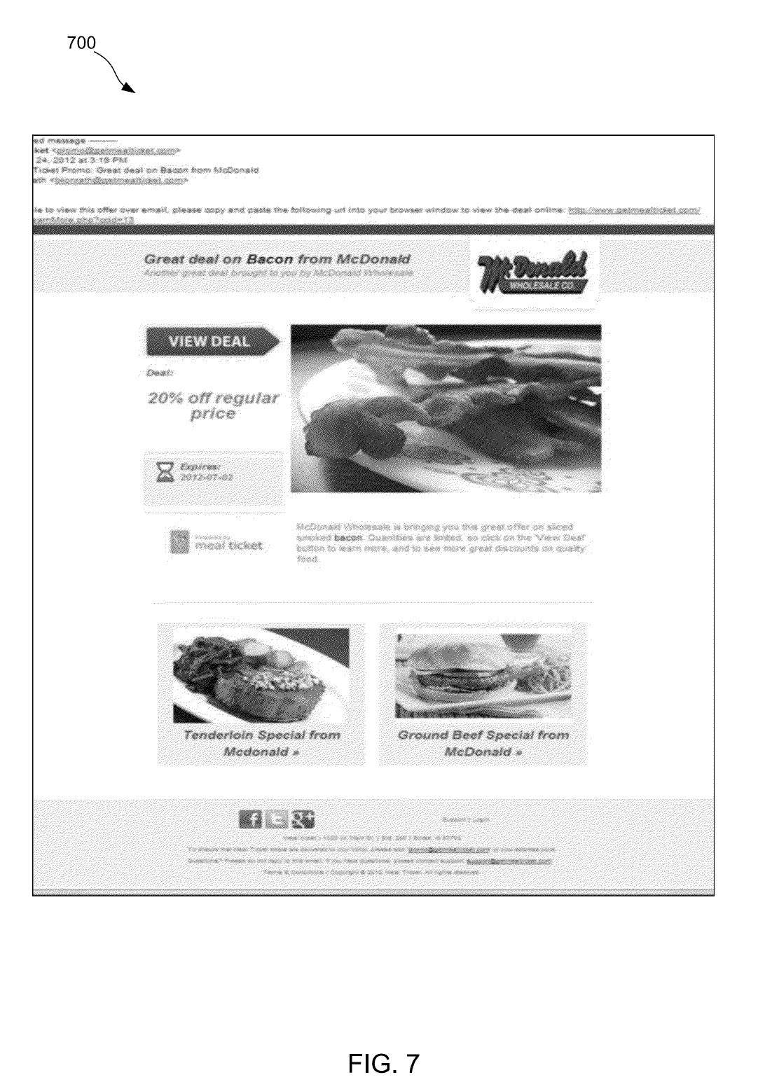

FIG. 8 shows a diagrammatic representation of one embodiment of a machine in the exemplary form of a computer system; and

FIG. 9 illustrates an embodiment of a loyalty and rewards tracking platform.

### DETAILED DESCRIPTION

The present disclosure relates generally to wholesale food distribution and marketing. More specifically, but without limitation, the present disclosure relates to a platform for enhancing distribution and marketing of wholesale food between a producer, distributor, and retailers.

The word “exemplary” is used herein to mean “serving as an example, instance, or illustration.” Any embodiment described herein as “exemplary” is not necessarily to be construed as preferred or advantageous over other embodiments.

For the purposes of this disclosure, “retailers” primarily include restaurants, but can also include grocery stores and any other retail establishment where food is sold (e.g., 7-11, TARGET, bowling alleys, baseball stadiums).

For the purposes of this disclosure, a “promotion” is a digital object that includes information regarding products that can be sampled or ordered. The promotion can include any digital document embedded in, attached to, or otherwise included in a digital message, such as an e-mail message.

The systems and methods disclosed herein are carried out in the context of three entities: a food manufacturer (the “manufacturer”), a food distributor (the “distributor”), and a food retailer (the “retailer”). The manufacturers produce food products, which are distributed by one or more distributors to one or more retailers. Existing methods of selling food products are sometimes ineffective at matching manufacturer supply with restaurant demand since there is little data sharing between the manufacturer, the distributors, and the retailers.

The present disclosure augments and replaces some of current sales and marketing functionality in the food services supply chain, and in particular where promotions (e.g., rebates and specials) on bulk food are delivered to retailers via sales people, mail, paper brochures, and other analog modes. Some aspects of the present disclosure access and analyze manufacturer, distributor, and retailer data in order to find overlap between manufacturer supplies and promotions and retailer demands, and to provide distributors with targeted promotions that can be passed on to retailers along with automated systems of receiving and responding to retailer food product orders in response to the promotions.

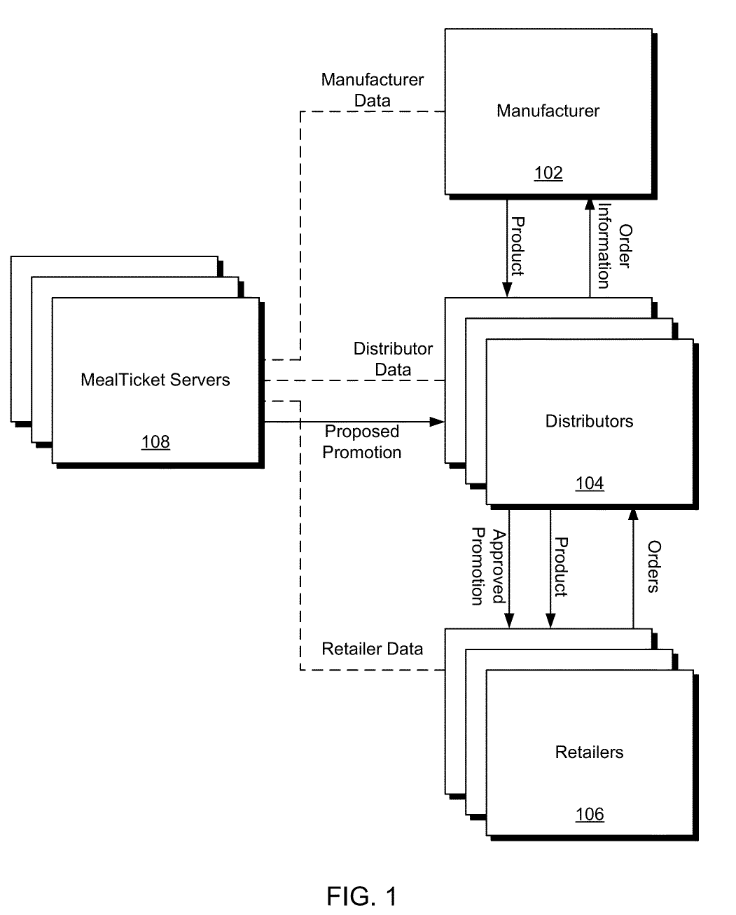

FIG. 1 illustrates a system comprising a manufacturer 102, distributors 104, retailers 106, and one or more MealTicket servers 108. The manufacturer 102 provides food products to the distributors 104, who stock the manufacturer's food products, and possibly also food products from other manufacturers, and then distribute the stocked food products to retailers 106 (e.g., restaurants). Data regarding the manufacturer 102, the distributors 104, and the retailers 106 is accessed or crawled by the MealTicket server 108. The MealTicket server 108 analyzes this data and generates lists of retailers for potential distribution of manufacturer promotions. The manufacturer 102 can modify these promotions and/or the lists of retailers, and the promotions along with the lists are then passed to the distributors 104 for approval. If approved, the promotions are then passed to those retailers 106 on lists approved by the both the manufacturer 102 and the distributors 104. Retailers 106 can place orders through the promotions (e.g., via a “Buy Now” button or a link to an ordering webpage) and the orders can be returned to the distributors 104 to be filled. At the same time, the MealTicket servers 108 can track actions taken relative to the promotions in order to provide analyses to the manufacturer 102 and further to provide suggestions for modification to future promotions in order to increase the effectiveness of those promotions. For instance, the following data points can be tracked: restaurant contacts for each restaurant that received a promotion; which contact opened the promotion; how many times each contact opened the promotion; which restaurants or contacts within a restaurant placed orders; date and time for each order; date and time for each click or open of a promotion; and the source that brought a retailer to a webpage hosted on the MealTicket servers 108.

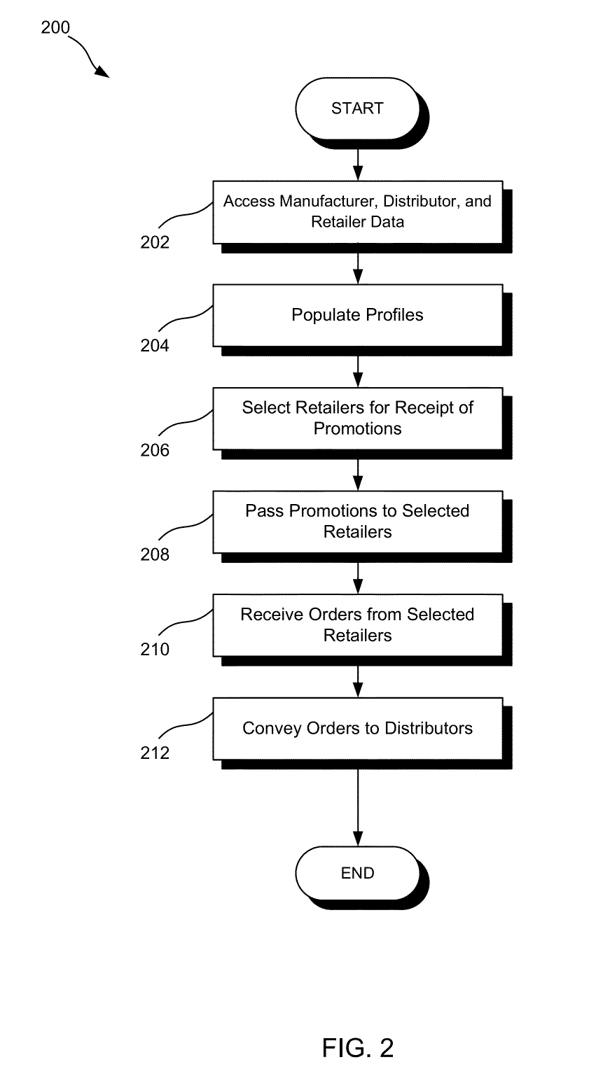

Traditionally, manufacturers do not have access to distributor data since distributors do not want manufacturers to gain an unfair market advantage. Here, such exchange of information is made possible by providing consideration to the distributors in return for the sharing of distributor data with the MealTicket servers 108. MealTicket servers 108 can also ‘anonymize’ data so that sensitive information, like specific customer names and addresses, are not shared with manufacturers, while less sensitive, but useful, information, such as product category purchasing behavior, can. In other words, the MealTicket servers 108 can filter, conceal, or encode certain information such as sensitive information. FIG. 2 illustrates one embodiment of a method for selling food products. The method 200 begins by accessing manufacturer, distributor, and retailer data, such as that for the types of foods being purchased and which retailers are purchasing from which distributors. This accessing is performed via an access operation 202. This data can then be used to populate profiles for the manufacturers, distributors, and retailers. These profiles can then be analyzed to select retailers for receipt of promotions in a select operation 206. In a pass operation 208, promotions can then be passed to the selected retailers. Retailers can then choose to make orders or order samples based on the promotions, and the orders can be received in a receive operation 210. The orders can then be conveyed to the distributors in a convey operation 212 so that the orders can be processed and fulfilled.

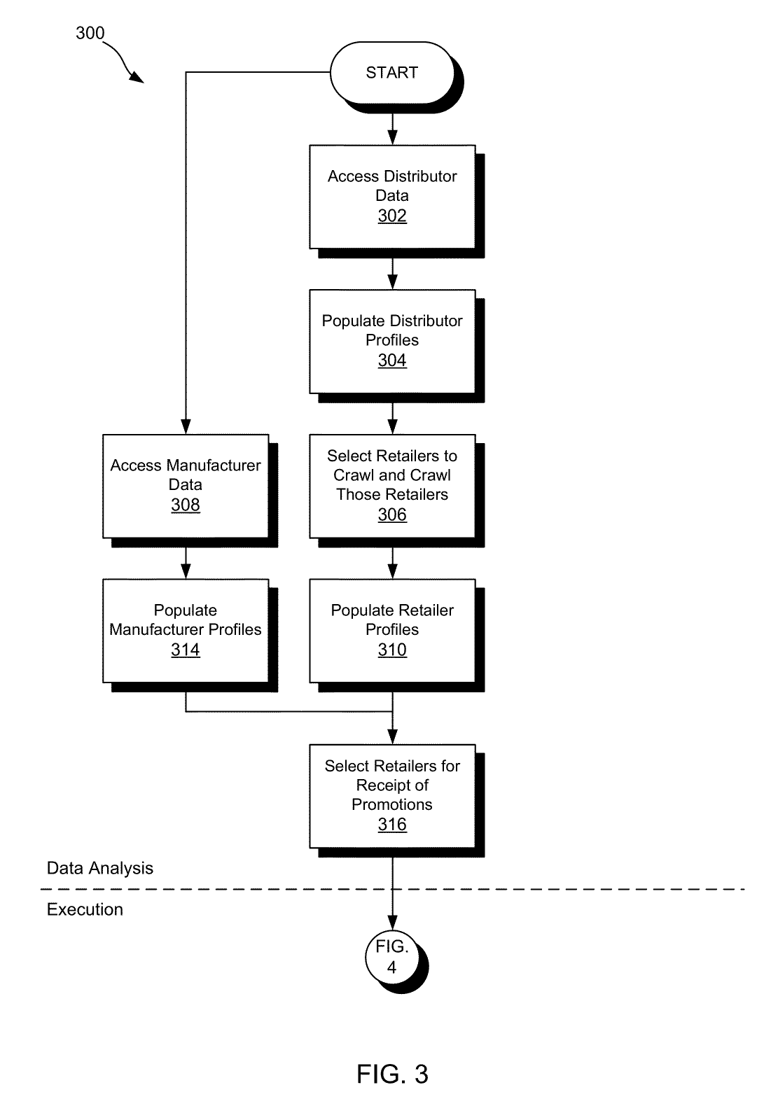

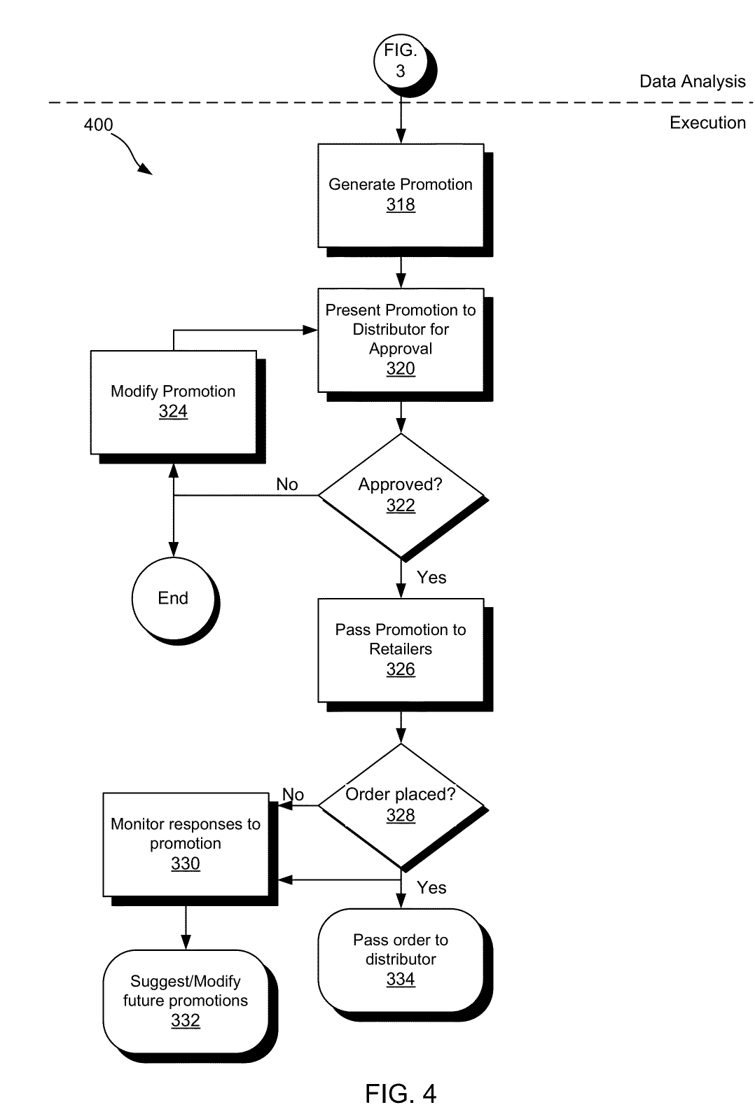

FIGS. 3-4 illustrate another embodiment of a method for selling food products. The method 300 can be broken into a data analysis portion (illustrated in FIG. 3) and an execution portion (illustrated in FIG. 4). The method 300 begins by accessing distributor data in an access operation 302. This data can be used to populate distributor profiles in a populate distributor profiles operation 304. Based on the distributor profiles 304, a select retailers operation 306 can select retailers to crawl and then perform a web crawl for data on those retailers. The retailer data can then be used to populate retailer profiles in a populate retailer profiles operation 310. In parallel to operations 302-310, manufacturer data can be accessed in an access manufacturer data operation 308. The manufacturer data can then be used to populate manufacturer profiles in a populate manufacturer profiles operation 314. The profiles of both retailers and manufacturers can then be used to select retailers for receipt of promotions in a select retailers operation 316.

The next operation can be seen in FIG. 4 as part of the execution portion of the method 400. A generate promotion operation 318 generates a promotion for the selected retailers where the promotion is selected using the profiles. The promotion can then be presented to a distributor for approval in a present promotion operation 320. If the promotion is approved by the distributor, as determined by decision 322, then the promotion can be passed to the food retailers in a pass promotion operation 326. If the promotion is not approved, then it may be modified in a modify promotion operation 324 and again presented to the distributor for a second approval. This process can continue until the distributor approves a version of the promotion. Once the promotion has reached the retailers, the retailers can place orders, or order samples based on the promotion. If an order is not placed, as determined by decision 328, then a monitor responses to promotion operation 330 can record the response for later analysis. The monitor responses to promotion operation 330 can also record the response when an order is placed, and the order can be passed to the respective distributor in a pass order to distributor operation 334. Finally, the recorded orders, or lack thereof, can be used to suggest or modify future promotions in a suggest/modify future promotions operation 332.

In order to identify market opportunities for a manufacturer, the access distributor data operation 302 accesses data describing a distributor's prior transactions including which food retailers are being serviced by the distributor and what food products those food retailers purchased from the distributor. For instance, it may be useful to a major poultry manufacturer to know that competitors have an unusually large market share in the Pacific Northwest, and thus this presents a market opportunity where the major poultry manufacturer should direct promotions. Distributor data can be selected from, but is not limited to, the following list: date a food retailer purchased a food product; sales representative taking the order; distributor product number (e.g., SKU) identifying the food product; manufacturer product number identifying the food product; name of the manufacturer who produces the food product; item name for the food product; food retailer who purchased the food product; address of the food retailer who purchased the food product; quantity of the food product purchased; and category of the food product purchased. The access distributor data operation 302 can further involve receiving the above-noted data from a distributor or extracting said data from a server in which said data resides.

The populate profile operations 304, 310, and 314 can populate existing profiles or create new ones where one does not exist.

The select retailers to crawl operation 306 can include identifying retailers that match certain criteria associated with a manufacturer profile. For instance, the select retailers to crawl operation 306 may select retailers that are being serviced by a given distributor.

The select retailers to crawl operation 306 can identify retailers that match certain criteria associated with a manufacturer profile. For instance, the select retailers to crawl operation 306 may select retailers that are being serviced by a given distributor. In some cases, retailers may also be selected based on analysis as to where market penetration is below a target.

Having selected certain retailers, the operation 306 can crawl the Internet and collect information that can indicate what food products each of the selected retailer uses and thus may be interested in purchasing. Data that can be collected in the select retailers to crawl operation 306 includes, but is not limited to the following: contact information (e.g., e-mail, website URL, address, phone number), food retailer type (e.g., pub, fine dining restaurant, breakfast diner, natural foods grocer, etc.), and details of a menu. A retailer can be categorized in one or more different retailer types. Crawling is typically performed via software, where text parsing, for instance, can be used to collect retailer ingredients from online menus. Such menus can be accessed on retailer websites or on websites that conglomerate ingredient lists. In one embodiment, the crawling can be performed manually and in some embodiments the crawling can be performed via a combination of software and human data collection. For instance, text parsing of an online menu for a restaurant can be performed to create a listing of ingredients that a restaurant utilizes.

The retailer profile can include categories of ingredients that the retailer uses as well as location/region and other descriptors of the retailer.

The manufacturer profile can include, but is not limited to, the following: manufacturer product identification (e.g., SKU), item name of a food product, description of the food product, category, and manufacturer name. In some cases, there can be more than one level of category, for instance “top level category,” “secondary category,” and “tertiary category.” The top level category can be the broadest (e.g., protein, dairy, produce, etc.), while the secondary category can be more detailed (e.g., poultry), and the tertiary category can be even further detailed (e.g., chicken breasts).

The select retailers for receipt of promotions operation 316 can perform analysis of the profiles to identify market opportunities for the manufacturer and distributors. In other words, this operation 316 involves determining which retailers to send promotions to or which ones to direct marketing campaigns towards. The select retailers for receipt of promotions operation 316 can consider where market penetration is lower than a desired target. The selection can be limited to a certain scope, such as a geographic region and/or a food category. For instance, a promotion may be limited to Northeast seafood restaurants. Zip codes, states, counties, and cities are other geographical boundaries that can be used to define the scope of a promotion. A list of retailers can be generated based on this scope.

In one embodiment selection can be manually carried out via showing a visual comparison of what distributors sell into a restaurant by category compared to the category breakdown of the restaurant's menu data. This provides a high level view of the category opportunities within the restaurants.

This list can then be filtered based on distributor sales data and/or restaurant menu data. The operation 316 can include generation of multiple lists in this fashion for each distributor, and the distributor can then select one or more of these lists to use in sending promotions or targeting campaigns to retailers.

A filter based on distributor sales data can filter based on those retailers that have purchased a selected food product in the recent past. The filter can target those retailers that have purchased a similar product from a different manufacturer. The filter may remove all retailers but those who purchase a complimentary product, but not the selected product. In one embodiment, the filter can filter out all retailers except those who have not purchased the promotion product.

A filter based on restaurant menu data can filter based on those retailers that have matching product categories with the promotional product. Alternatively, the filter can leave those retailers that use complimentary products but not the promotional product. In some embodiments, retailers can be filtered via this and the distributor sales data filter.

The select retailers for receipt of promotions operation 316 can be automated, manual, or a combination of the two. The goal of selection is to identify those retailers that are most likely to respond to the promotion. As such, selection can be based on retailer type, buying history, distributor, and/or region, to name a few. In some cases the manufacturer and/or distributor can manually assist in making the selection of retailers to send the promotions to. For instance, a manufacturer can control parameters of the filter based on distributor sales data and/or restaurant menu. In another example, the manufacturer may select the geographic scope and/or food categories in which retailers are selected from.

In one embodiment (not illustrated), reports are generated based on the profiles, and a manufacturer can manually, or the MealTicket servers 108 can autonomously, or a combination of the two can, use the reports to select retailers for receipt of promotions in the select retailers operation 316. Reports can be generated for markets that describe a geographic or product-centric set of distributors or retailers, for instance. As an example, a report for Midwest fast-food restaurants could be generated or one could be generated for seafood restaurants across the whole nation.

Reports describing retailers may describe types of foods that a retailer uses and thus may be interested in purchasing. Reports describing distributors may also describe the retailers that given distributors sell to, the types of foods that a distributor sells, the types of foods that a distributor sells to each retailer or to types of retailers, quantities of foods sold, and market share, to name a few. For instance, a distributor report may show that a distributor sells a first manufacturer's chicken at 30 restaurants, that the distributor sells to 40 restaurants in total including sales of other manufacturers' products, there are 1000 restaurants in the city, and that therefore the manufacturer has 50% of the distributor's business and 3% of the city's business.

One or more promotions and/or campaigns can be generated in a generate promotions operation 318. The generate promotions operation 318 can occur after the select retailers operation 316, as illustrated, or at the same time as, or before the select retailers operation 316 is carried out. Existing promotions (e.g., rebates, specials, and sales) as well as new promotions can be the basis for the generate promotions operation 318. In some embodiments, the promotions that are generated are merely digital versions of analog promotions (e.g., brochures or mailers).

Promotions can include information on and sales opportunities relative to one or more food products. Each food product can be associated with a description, images, cooking/preparation instructions, suggested serving sizes, nutritional information, and product yield, to name a few. Product SKUs, current inventory, price per case, and items per case are further examples of data that can be associated with each product in a promotion.

Each promotion can have parameters such as pricing and discounts, a length that a promotion will be active, the types of restaurants that the promotion will be sent to, geographic regions in which the promotion will be delivered in, and/or the distributor that will fulfill orders from the promotion.

The promotion can be generated automatically or can be approved and/or created and/or modified by a manufacturer via a promotion user interface (UI). The promotion user interface can enable a manufacturer to enter the above-noted information about products and/or promotion parameters. The promotion user UI can also enable distributors to modify or suggest modifications to the promotion if they do not approve the promotion. In some cases, the UI can further be used by retailers to view promotions and order products or samples. The UI can be tailored for each of the manufacturer, distributor, and retailer and may therefore appear differently to each entity as well as contain different functionality.

The promotions are then presented to the distributor (unless the distributor created the promotion) for approval in the present promotion operation 320. At the same time, the proposed promotion can be passed to the MealTicket servers 108 that are responsible for overseeing and carrying out the method 300. The MealTicket servers 108 may be tasked with further approval of the promotion and may make suggestions for modification to the promotion. In one embodiment, a promotion can be presented to a distributor's sales representative along with notification that the promotion is awaiting approval (e.g., the promotion can be sent to the sales representative via e-mail).

Approval in decision 322 can include approval by the distributor and/or approval by the remote servers. If either entity disapproves of the promotion, then the modify promotion operation 324 can suggest modifications for approval. The modify operation 324 can be carried out via the remote servers, via operators of the remote servers, or via a distributor who does not approve of a proposed promotion.

In some embodiments, rather than modifying a disapproved promotion, the method 300 may simply come to an end.

When approved, the promotion can be passed to the retailers selected in select operation 316. In some cases the promotion is sent via e-mail and in others via text message. Other means of sending the promotion to the retailers are also envisioned.

The food retailer(s) receives the promotion and can then place an order as determined by the order placed decision 328. Orders can be placed via the promotions. For instance, promotions can include digital links to webpages where products described in the promotions can be purchased. Alternatively, the promotions can include digital boxes or other selection methods that can be used to create orders that can be manually or automatically transmitted back to distributors. In some cases, the promotions can include links to distributor web pages. In other embodiments, the promotion can include one or more sample ordering mechanisms such as a web link or an automated response to a distributor. Where a retailer is directed to a webpage, a login may be required, and once logged in, the retailer may be presented with a webpage that is tailored to the specific retailer. For instance, the webpage may include shipping address and billing information for the entity logging in, such that the process of ordering samples or products is expedited. The webpage may also include further promotions that can be viewed and selected by a retailer.

Each promotion can further include secondary promotions or links to secondary promotions. Secondary promotions are promotions that have been used previously, perhaps on the same retailers, but perhaps on different retailers, and have yet to expire.

Each promotion can further include backup promotions or links to backup promotions. Backup promotions are typically not sent out as promotions or offers on their own, but instead are included in a promotion for other products or can be viewed on a webpage that retailer browsers are directed to when they select a link in an e-mail or other type of promotion.

If an order is placed, then an indication is sent to the distributor (e.g., an e-mail or text message) which instructs the distributor to collect money from the food retailer for the purchase, and to deliver the food product from inventory. This occurs in a pass order to distributor operation 334 carried out by the MealTicket servers 108. The indicator can be sent to a salesperson of the distributor, who, for instance, may be responsible for accounts that include the retailer that placed the order. In some embodiments, the MealTicket servers 108 can be fully integrated with the distributor's 104 point-of-sale and order entry systems. For instance, after an order is placed, a text or data string can be passed to each distributor 104 and the orders can be automatically entered into a back end of those POS systems. For instance, JSON formatted messages or data strings can be passed to each distributor 104.

A second indicator can be sent to the manufacturer, which lets the manufacturer know that a purchase was made. In some embodiments, the indicators can be grouped with indicators for various purchases, and the distributor and manufacturer may only receive a single document per a certain time period (e.g., once a day). In some cases, the distributor receives the indicator immediately when a purchase is made so that the product can be sent out as soon as possible, while the second indicators can be grouped and sent to a manufacturer once per time period. This is because prompt delivery of the second indicator to the manufacturer is not as important as prompt delivery of the first indicator to the distributor.

The MealTicket servers 108 can track promotions and returned indicators and keep an organized hierarchy of relationships between manufacturers, distributors, and retailers.

The method 400 may also monitor retailer actions in response to a promotion. Whether an order is placed or not, a monitor responses to promotion operation 330 records retailer orders or lack thereof, and can record retailer actions taken relative to the promotion (e.g., clicks, orders, views, etc). This data can be reported back to the manufacturer to enhance future promotion delivery. Alternatively, or in parallel to, a suggest/modify future promotions operation 332 can automatically make suggestions for future promotions or can make modifications to future promotions when they are generated. The suggest/modify future promotions operation 332 can use the data from the monitor responses to promotion operation 330 to make said suggestions.

Reports will also be passed to each distributor detailing results from each promotion. For instance, a report may indicate which retailers, and possibly which individuals, within each retailer opened the promotion and which retailers and contacts placed an order. Reports can also indicate a time of opening or clicking within a promotion as well as a time that orders were placed.

Reports can also be generated for manufacturers to review. This manufacturer report can show total numbers of orders placed in response to a given promotion, but may be displayed with a higher level of detail than the distributor reports.

One of skill in the art will recognize that the order of operations illustrated in FIGS. 3-4 can be modified without departing from the spirit of the disclosure. For instance, the selection of retailers operation 316 need not occur before the generate promotion operation 318. In some cases, the selection of retailers can be performed after the promotion is generated and after the promotion is approved by the distributors.

### Loyalty Platform

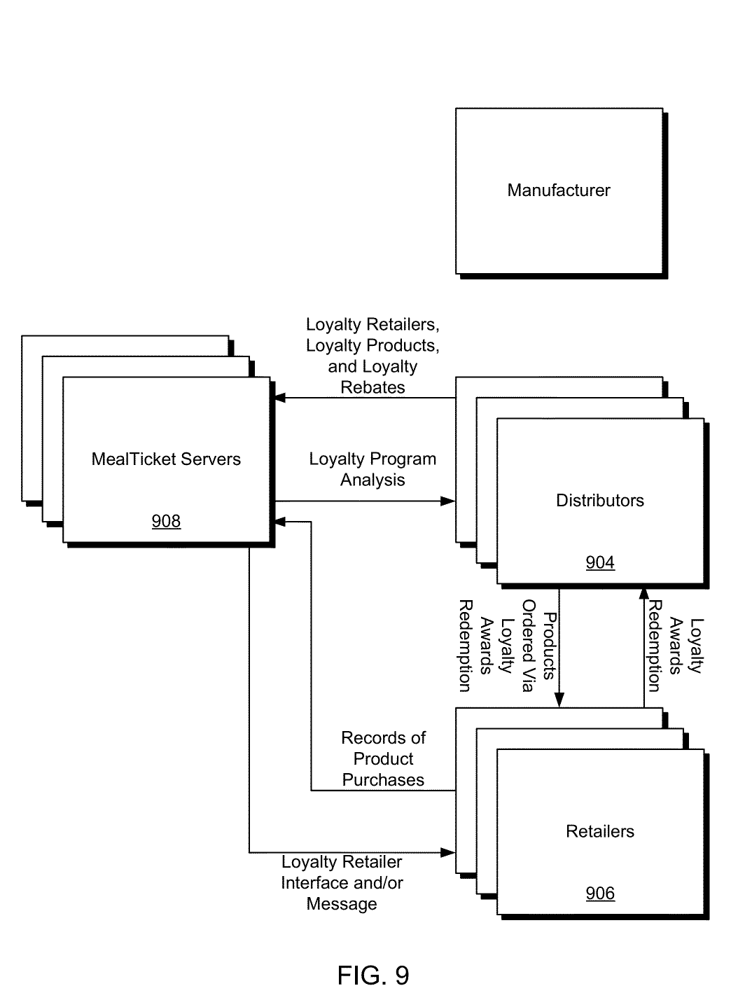

FIG. 9 illustrates an embodiment of a loyalty and rewards tracking platform. Distributors 904 provide lists of loyalty retailers, loyalty products, and loyalty awards associated with the loyalty products to the MealTicket servers 908. The MealTicket servers 908 also track purchases made by retailers 906 that are in the lists of loyalty retailers. The MealTicket servers 908 then compare the purchased products to the loyalty products provided by the distributors 904 and tally loyalty awards earned for each loyalty retailer based on the purchases. These awards can accrue to an account for each retailer 906. Information describing the loyalty awards earned can then be returned to the retailers 906 via either a loyalty retailer interface (e.g., a web interface) or via e-mail. In one embodiment, the e-mail can be sent periodically (e.g., weekly). The information can also include a current balance of loyalty awards (e.g., rebates) earned and redeemed. This information can also be based on the account for each loyalty retailer. The information can include a summary of purchasing activity and accrued loyalty awards, for example. The loyalty retailer interface can also be used to redeem loyalty awards directly with the distributors 904.

The MealTicket servers 908 also analyze the records of product purchases, the information provided to the retailers 906 regarding their loyalty awards accounts, and information describing the redemption of loyalty awards. This analysis seeks to determine an effectiveness of the loyalty program and provides results of this analysis to the distributors 904 in the form of a loyalty program analysis. In one embodiment, the results of the analysis can show how a loyalty program increased or is capable of increasing purchases of target products. Similarly, the analysis can show how the loyalty program causes or is capable of increasing overall spending by a given retailer 906. Distributors 904 can use these results to see which products and brands experienced the greatest benefits from associated loyalty programs.

### Mobile Application

In another set of embodiments, the MealTicket servers 908 can host a web application targeted at distributor sales representatives (DSRs). The web application can use location information to assist DSRs onsite with retailers 906 in order to better tailor their sales pitches to retailers 906. In one embodiment, the MealTicket servers 908 can collect location information (e.g., GPS coordinates) from DSR mobile devices and use this information to guess which retailer 906 a DSR is approaching or engaging with. The web application can suggest the retailer 906 and also or alternately provide a list of retailers 906 that the DSR is most likely approaching or engaging with. For instance, a drop-down selection menu of a plurality of retailers 906 can be provided. The drop-down selection menu may include retailers 106 assigned to the DSR. Further, the retailers 106 in the drop-down selection menu may be those associated with a given DSR. In an embodiment, the drop-down selection menu can be presented when the MealTicket servers 108 are unable to determine an accurate identity of the retailer 106 based on location information alone. In another embodiment, a suggested retailer 906 can be presented along with the drop-down selection menu, where the drop-down selection menu is presented in case the suggested retailer 906 is not the correct one.

In an embodiment, the web application will use a mobile device's GPS or other coordinates to locate restaurants nearby that are not currently buying from the DSR or distributor that is using the application. The DSR can use the application to gather information about that restaurant, show the restaurant relevant products/promotions, and attempt to convert that customer into a client. Activity on this feature can be tracked and reported, allowing the DSR to monitor progress with new prospects.

Once a retailer 906 is identified, either automatically or via DSR manual selection, the web application can suggest categories of products and promotions, or specific products and promotions, for the DSR to use in making sales pitches to the selected retailer 906. Categories of products can include, but are not limited to, hotsheet, closeouts, trends, and loyalty. The recommendations can be based on the same logic and intelligence discussed with reference to the MealTicket servers 108 illustrated in FIG. 1.

Hotsheet and closeout categories of products can be suggested based on distributor-established parameters. Products in these categories can be selected by the distributors 904 and can include products currently under promotion. The MealTicket servers 908 can also select the products presented to the DSR based on logic that estimates which products are a best fit for a given retailer 906. For instance, the MealTicket servers 908 can consider whether a retailer 906 is likely to buy a given product, whether the retailer 906 already purchased this product or similar types of products, and whether the product compliments products that the retailer 106 already purchases, to name three non-limiting examples.

Trends can present products to the DSR based on whether the retailer 906 shows a trend of buying more or less of the product. For instance, given a first and second product, where the retailer 906 has been buying an increasing number of the first product each month, and a decreasing number of the second product each month, the web application may suggest the first product since the upward trend indicates a greater likelihood that the retailer 906 will purchase the first product.

The loyalty category suggests products to the DSR that have loyalty awards associated with them and can substitute for products that the retailer 906 already purchases, but that are not associated with loyalty awards. In an embodiment, the loyalty category products are only suggested to DSRs who are part of the loyalty awards program.

As the DSR is viewing multiple suggested products, and after the DSR selects one or more of the suggested products, further details of each product can be viewed (e.g., description, pictures, specials, or rebates). The DSR can place an order from the interface showing these additional details, and the web application can then send the DSR and a sales supervisor of the DSR (e.g., sales manager) an e-mail or other type of message confirming the order.

The web application can also store and analyze what a DSR does with suggested products. For instance, where a DSR tends not to use certain suggested products or certain types of suggested products, the web application may be less-likely to suggest those products or types of products in the future. The analysis may look at where the web application was used, what promotions and products were promoted to the retailer, and what products were ordered, to name a few. The analysis may also look at whether the products were shown on-location (e.g., at a retailer's 906 facility) or off-site (e.g., at a restaurant or conference). The web application may also present this information in a report to the distributor 904 associated with a given DSR in addition to analyzing this information. The distributor and DSRs can also use the reporting function to track prospecting activity, for example, tracking how many prospects were visited, what information was gathered, and whether those prospects were converted into paying customers.

This web application can be tailored for mobile devices, but may also be embodied in applications configured for tablet computers, laptop computers, ultrabooks, wearable computing devices (e.g., smart watches and smart goggles (e.g., GOOGLE GLASS)), and other mobile computing systems as well as desktop computing systems. The web application can be embodied in various systems such as mobile-ready HTML5, IOS, and ANDROID, to name three non-limiting examples.

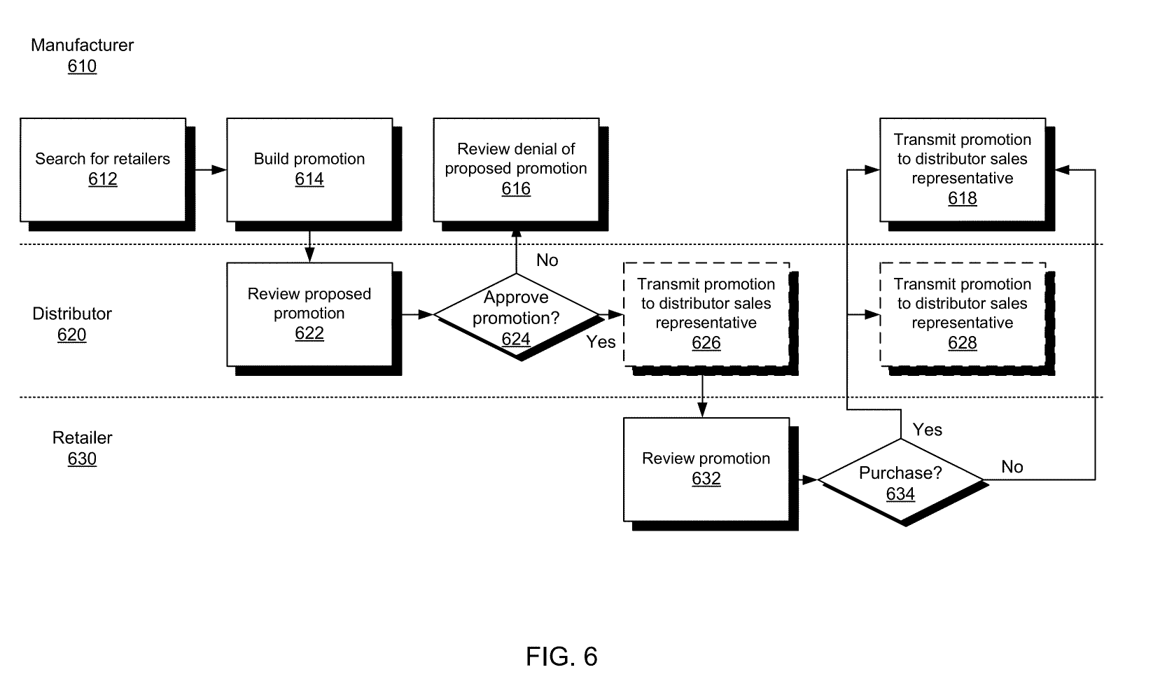

FIG. 6 illustrates another method for facilitating sales and marketing between food industry manufacturers, distributors, and retailers. Operations performed at each of the manufacturer 610, distributor 620, and retailer 630 are separated via dashed lines. In this method, a manufacturer 610 can search a database for retailers based on geography, retailer type, and/or consumer demographics in a search operation 612. MealTicket servers, remote from the manufacturer 610, then build promotions for the retailers found (and optionally selected from search results) in the search (block 614). The MealTicket servers then transmit the proposed promotions to the distributor 620 for approval. The distributor 620 reviews (block 622) the proposed promotion(s) and if it approves of the promotion(s) in decision 624 then the promotion is transmitted to a retailer 630. Optionally, notice of the approved promotion can be transmitted to a distributor sales representative in transmit operation 626. Depending on whether the distributor sales representative is involved, the promotion can be passed directly to the retailer 630 (e.g., via e-mail) or the distributor sales representative can present the promotion to the retailer 630 (e.g., via e-mail or via in-person solicitation). If the proposed promotion is not approved at the decision 624, then the manufacturer 610 can be asked to review the denial of the proposed promotion in review operation 616. A new proposed promotion can then be generated with changes suggested by the MealTicket servers and/or input from the manufacturer.

Once a retailer 630 reviews the promotion (block 632) the retailer 630 decides whether to make a purchase. If a purchase is not made (as determine by decision 634), then information describing the failure to purchase can be tracked and reported back to the manufacturer 610 in a report operation 618. If the retailer 630 does make a purchase, then the distributor sales representative can optionally be notified of the purchase (block 628) and can take actions to fulfill the order. Information regarding the order can also be transmitted back to the manufacturer 610 as part of the report operation 618. Information provided in the report operation 618 can be used to tailor or modify future proposed promotions.

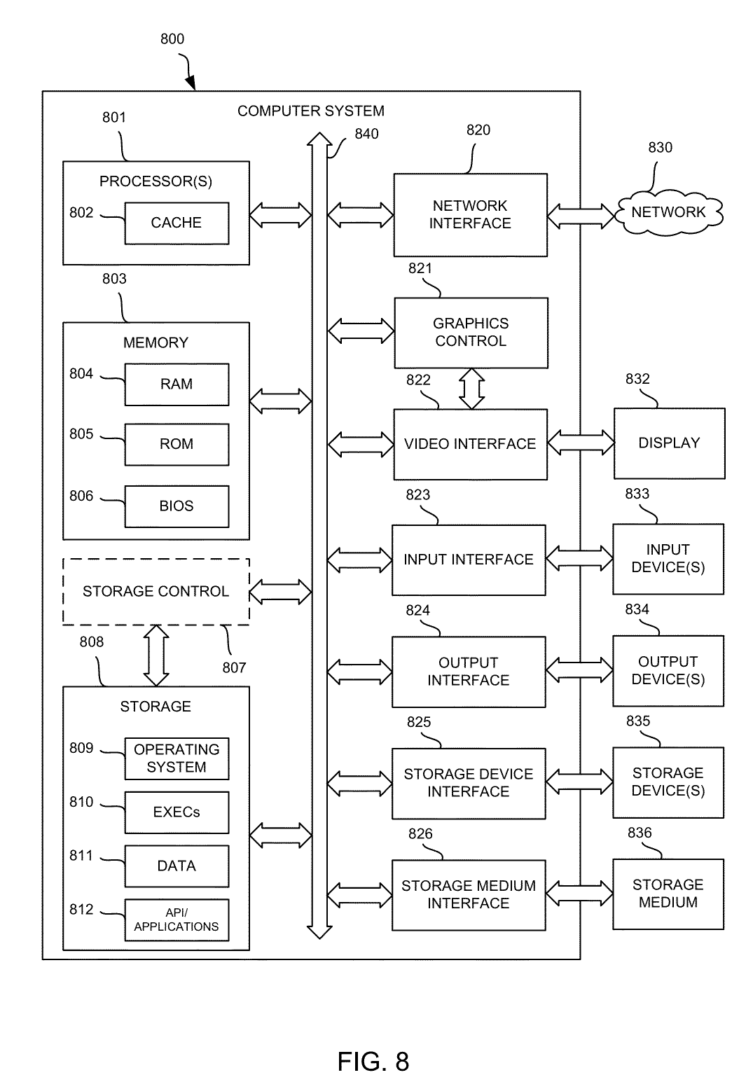

The systems and methods described herein can be implemented in a machine such as a computer system in addition to the specific physical devices described herein. FIG. 8 shows a diagrammatic representation of one embodiment of a machine in the exemplary form of a computer system 800 within which a set of instructions can execute for causing a device to perform or execute any one or more of the aspects and/or methodologies of the present disclosure. The components in FIG. 8 are examples only and do not limit the scope of use or functionality of any hardware, software, embedded logic component, or a combination of two or more such components implementing particular embodiments.

Computer system 800 may include a processor 801, a memory 803, and a storage 808 that communicate with each other, and with other components, via a bus 840. The bus 840 may also link a display 832, one or more input devices 833 (which may, for example, include a keypad, a keyboard, a mouse, a stylus, etc.), one or more output devices 834, one or more storage devices 835, and various tangible storage media 836. All of these elements may interface directly or via one or more interfaces or adaptors to the bus 840. For instance, the various tangible storage media 836 can interface with the bus 840 via storage medium interface 826. Computer system 800 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 801 (or central processing unit(s) (CPU(s))) optionally contains a cache memory unit 802 for temporary local storage of instructions, data, or computer addresses. Processor(s) 801 are configured to assist in execution of computer readable instructions. Computer system 800 may provide functionality as a result of the processor(s) 801 executing software embodied in one or more tangible computer-readable storage media, such as memory 803, storage 808, storage devices 835, and/or storage medium 836. The computer-readable media may store software that implements particular embodiments, and processor(s) 801 may execute the software. Memory 803 may read the software from one or more other computer-readable media (such as mass storage device(s) 835, 836) or from one or more other sources through a suitable interface, such as network interface 820. The software may cause processor(s) 801 to carry out one or more processes or one or more steps of one or more processes described or illustrated herein. Carrying out such processes or steps may include defining data structures stored in memory 803 and modifying the data structures as directed by the software.

The memory 803 may include various components (e.g., machine readable media) including, but not limited to, a random access memory component (e.g., RAM 804) (e.g., a static RAM “SRAM”, a dynamic RAM “DRAM, etc.), a read-only component (e.g., ROM 805), and any combinations thereof. ROM 805 may act to communicate data and instructions unidirectionally to processor(s) 801, and RAM 804 may act to communicate data and instructions bidirectionally with processor(s) 801. ROM 805 and RAM 804 may include any suitable tangible computer-readable media described below. In one example, a basic input/output system 806 (BIOS), including basic routines that help to transfer information between elements within computer system 800, such as during start-up, may be stored in the memory 803.

Fixed storage 808 is connected bidirectionally to processor(s) 801, optionally through storage control unit 807. Fixed storage 808 provides additional data storage capacity and may also include any suitable tangible computer-readable media described herein. Storage 808 may be used to store operating system 809, EXECs 810 (executables), data 811, API applications 812 (application programs), and the like. Often, although not always, storage 808 is a secondary storage medium (such as a hard disk) that is slower than primary storage (e.g., memory 803). Storage 808 can also include an optical disk drive, a solid-state memory device (e.g., flash-based systems), or a combination of any of the above. Information in storage 808 may, in appropriate cases, be incorporated as virtual memory in memory 803.

Computer-readable tangible storage media can include instructions for carrying out the methods described in this disclosure. The instructions can be coded in HTML, CSS, PHP, and/or JAVASCRIPT, to name a few non-limiting examples. Underlying the functionality of this code can be one or more sets of data stored in a MYSQL database structure, although other forms of data storage can also be implemented. The web interface can be written in PHP with a MYSQL database, while JAVASCRIPT and jQuery can be used to implement some user interface features. HTML 5 can be used for markup and the web interface can be hosted in a cloud environment, such as at Rackspace. SENDGRID can be used to send e-mail promotions to retailers and can further be used to report actions taken relative to the promotions (e.g., opens, clicks, and orders). LUCENE can be used for full-text searching.

In one example, storage device(s) 835 may be removably interfaced with computer system 800 (e.g., via an external port connector (not shown)) via a storage device interface 825. Particularly, storage device(s) 835 and an associated machine-readable medium may provide nonvolatile and/or volatile storage of machine-readable instructions, data structures, program modules, and/or other data for the computer system 800. In one example, software may reside, completely or partially, within a machine-readable medium on storage device(s) 835. In another example, software may reside, completely or partially, within processor(s) 801.

Bus 840 connects a wide variety of subsystems. Herein, reference to a bus may encompass one or more digital signal lines serving a common function, where appropriate. Bus 840 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 800 may also include an input device 833. In one example, a user of computer system 800 may enter commands and/or other information into computer system 800 via input device(s) 833. Examples of an input device(s) 833 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof. Input device(s) 833 may be interfaced to bus 840 via any of a variety of input interfaces 823 (e.g., input interface 823) including, but not limited to, serial, parallel, game port, USB, FIREWIRE, THUNDERBOLT, or any combination of the above.

In particular embodiments, when computer system 800 is connected to network 830, computer system 800 may communicate with other devices, specifically mobile devices and enterprise systems, connected to network 830. Communications to and from computer system 800 may be sent through network interface 820. For example, network interface 820 may receive incoming communications (such as requests or responses from other devices) in the form of one or more packets (such as Internet Protocol (IP) packets) from network 830, and computer system 800 may store the incoming communications in memory 803 for processing. Computer system 800 may similarly store outgoing communications (such as requests or responses to other devices) in the form of one or more packets in memory 803 and communicated to network 830 from network interface 820. Processor(s) 801 may access these communication packets stored in memory 803 for processing.

Examples of the network interface 820 include, but are not limited to, a network interface card, a modem, and any combination thereof. Examples of a network 830 or network segment 830 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 830, may employ a wired and/or a wireless mode of communication. In general, any network topology may be used.

Information and data can be displayed through a display 832. Examples of a display 832 include, but are not limited to, a liquid crystal display (LCD), an organic liquid crystal display (OLED), a cathode ray tube (CRT), a plasma display, and any combinations thereof. The display 832 can interface to the processor(s) 801, memory 803, and fixed storage 808, as well as other devices, such as input device(s) 833, via the bus 840. The display 832 is linked to the bus 840 via a video interface 822, and transport of data between the display 832 and the bus 840 can be controlled via the graphics control 821.

In addition to a display 832, computer system 800 may include one or more other peripheral output devices 834 including, but not limited to, an audio speaker, a printer, and any combinations thereof. Such peripheral output devices may be connected to the bus 840 via an output interface 824. Examples of an output interface 824 include, but are not limited to, a serial port, a parallel connection, a USB port, a FIREWIRE port, a THUNDERBOLT port, and any combinations thereof.

In addition or as an alternative, computer system 800 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, or microcontroller. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A non-transitory, tangible computer readable storage medium, encoded with processor readable instructions to perform a method for facilitating marketing and sales between food industry manufacturers, distributors, and retailers, the method comprising:
parsing data collected regarding the food industry manufacturers, distributors, and retailers, including web crawling one or more websites to collect at least a portion of data on the food industry retailers;
populating profiles of the food industry retailers based on the parsing;
analyzing the food industry retailer profiles to select one or more food industry retailers for targeting of promotions for food products produced by one of the food industry manufacturers;
generating one or more promotions describing one or more food products produced by the one of the food industry manufacturers;
transmitting the one or more promotions to one of the food industry distributors for approval;
receiving approval of the one or more promotions from the one of the food industry distributors;
transmitting the one or more promotions to the one or more retailers selected for targeting of promotions;
receiving, in response to the transmitting, one or more food product orders from the one or more retailers selected for targeting of promotions; and
passing the food product orders to the one or more food industry distributors for fulfillment of the orders.

2. The non-transitory, tangible computer readable storage medium of claim 1, further comprising tracking actions taken relative to the promotion in order to provide analysis to the manufacturer.

3. The non-transitory, tangible computer readable storage medium of claim 2, further comprising analyzing the actions and determining suggested modifications to future promotions.

4. The non-transitory, tangible computer readable storage medium of claim 1, wherein the generating is based on automated analysis of reasons for success or failure of a previous promotion.

5. The non-transitory, tangible computer readable storage medium of claim 1, wherein the data that is parsed is collected on food industry retailers selected based on populated food industry distributor profiles.

6. The non-transitory, tangible computer readable storage medium of claim 1, wherein the data regarding the food industry distributors includes data from prior transactions between the food industry distributors and the food industry retailers and between the food industry distributors and the food industry manufacturers.

7. The non-transitory, tangible computer readable storage medium of claim 6, wherein the data regarding the food industry distributors includes data received from the food industry distributors.

8. The non-transitory, tangible computer readable storage medium of claim 1, wherein the data regarding the food industry retailers includes information indicating what food products the food industry retailers use.

9. The non-transitory, tangible computer readable storage medium of claim 1, wherein the data regarding the food industry retailers includes data parsed from digitally-accessible copies of food industry retailer menus.

10. The non-transitory, tangible computer readable storage medium of claim 1, wherein the one or more websites are selected based on matches between food industry manufacturer profiles and food industry retailers having a presence on the one or more websites.

11. The non-transitory, tangible computer readable storage medium of claim 1, wherein the transmitting is performed by the food industry distributor.

12. The non-transitory, tangible computer readable storage medium of claim 1, wherein the transmitting is performed by third-party servers that also perform the generating.

13. A non-transitory, tangible computer readable storage medium, encoded with processor readable instructions to perform a method for facilitating sales activities of a food industry distributor sales representative, the method comprising:
parsing data collected regarding food industry manufacturers, distributors, and retailers;
populating profiles of the food industry retailers based on the parsing;
generating promotions and recommended products to be transmitted to the food industry distributor sales representative based on the profiles of the food industry retailers;
collecting location information from a mobile computing device of the food industry distributor sales representative;
comparing the location information to the profiles of the food industry retailers to predict what food industry retailer the mobile computing device is proximal to; and
transmitting certain of the promotions and recommended products to the computing device, where the promotions and recommended products are predicted to be applicable to the food industry retailer that the mobile computing device is proximal to.

14. The non-transitory, tangible computer readable storage medium of claim 13, wherein the data that is parsed is collected on food industry retailers selected based on populated food industry distributor profiles.

15. The non-transitory, tangible computer readable storage medium of claim 13, wherein the generating is based on automated analysis of reasons for success or failure of a previous promotion.

16. The non-transitory, tangible computer readable storage medium of claim 13, wherein the data that is parsed is collected on food industry retailers selected based on populated food industry distributor profiles

17. The non-transitory, tangible computer readable storage medium of claim 13, wherein the data regarding the food industry distributors includes data from prior transactions between the food industry distributors and the food industry retailers and between the food industry distributors and the food industry manufacturers

18. The non-transitory, tangible computer readable storage medium of claim 17, wherein the data regarding the food industry distributors includes data received from the food industry distributors.

19. The non-transitory, tangible computer readable storage medium of claim 13, wherein the data regarding the food industry retailers includes information indicating what food products the food industry retailers use.

20. The non-transitory, tangible computer readable storage medium of claim 13, wherein the data regarding the food industry retailers includes data parsed from digitally-accessible copies of food industry retailer menus.
